(19) United States
(12) Patent Application Publication
(10) Pub. No.: US 2014/0195792 A1
(43) Pub. Date: Jul. 10, 2014

(54) HIDING BOOT LATENCY FROM SYSTEM USERS

(71) Applicant: INTEL CORPORATION, Santa Clara, CA (US)

(72) Inventor: Yen Hsiang Chew, Georgetown (MY)

(21) Appl. No.: 14/125,138

(22) PCT Filed: Oct. 2, 2012
(86) PCT No.: PCT/US2012/058472

§ 371 Date: Dec. 10, 2013

(30) Foreign Application Priority Data
Oct. 3, 2011 (MY) PI 2011004734

(51) Int. Cl. G06F 9/44; G06F 1/32

(52) U.S. Cl. CPC G06F 9/4411; G06F 1/325
USPC 713/2

(57) ABSTRACT

Methods and systems may provide for identifying a proximity condition between a system and a potential user of the system. In addition, one or more boot components of the system can be activated in response to the proximity condition, wherein one or more peripheral devices associated with the system are maintained in an inactive state. In one example, at least one of the one or more peripheral devices is placed in an active state in response to detecting an activation condition of the system.

### BACKGROUND

1. Technical Field

Embodiments generally relate to boot latency. More particularly, embodiments relate to hiding boot latency in user-based systems.

2. Discussion

Modern vehicles may be equipped with in-vehicle infotainment (IVI) systems that provide information-based media content to occupants of the vehicle. A typical IVI system may include an embedded computer, a control panel and a display, wherein the system can be booted (e.g., activated) by the occupants once they have entered the vehicle and the vehicle has been started. Relatively long boot times, however, can have a negative impact on user experience. For example, the time period between the occupant turning on the IVI system via the control panel and the desired content being shown on the display may be a minute or more. Although certain approaches to reducing boot time may involve the use of a smaller boot loader instead of a standard basic input/output system (BIOS) and/or operating system (OS), there remains considerable room for improvement.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a user-based system according to an embodiment; and

FIG. 2 is a flowchart of an example of a method of activating a user-based system according to an embodiment.

### DETAILED DESCRIPTION

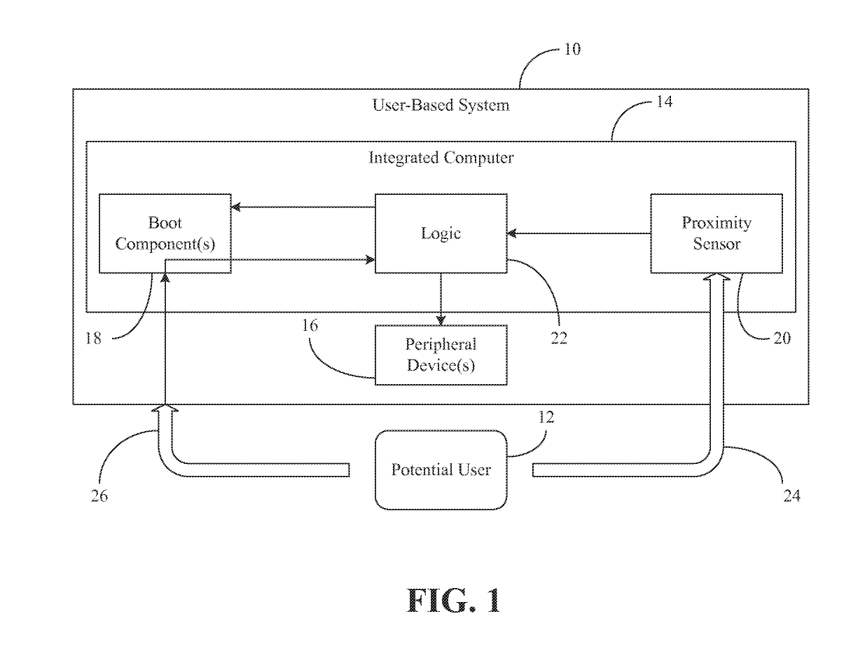

Turning now to FIG. 1, a user-based system 10 is shown in which a potential user 12 may interact with an integrated computer 14 of the system 10. The system 10 could be, for example, a vehicle, wherein the integrated computer 14 may represent an in-vehicle infotainment (IVI) device that provides information-based media content to occupants of the vehicle, or a navigation system that uses Global Positioning System (GPS) technology to guide operators of the vehicle to a destination of interest. The system 10 might also be a computing system such as a personal computer (PC), server, workstation, mobile Internet device (MID), personal digital assistant (PDA), wireless smartphone, media player notebook computer, tablet device, and so forth, that enables users to conduct various activities such as word processing, web browsing, media playback, social networking, etc. In still another example, the system 10 could include an automated teller machine (ATM) that enables individuals to withdraw funds and conduct other banking account related activities. Other user-based systems such as industrial control (e.g., programmable logic control/PLC) systems, embedded systems, Web televisions (TVs), set-top boxes, and so forth, may benefit from the techniques described herein.

In the illustrated example, the integrated computer 14 includes one or more peripheral devices 16 such as a display, control panel, sound system, integrated camera, touch screen, etc., which the potential user 12 may use to perceive and/or control information associated with the integrated computer 14. Thus, in the scenario of an IVI device or a navigation system, the peripheral devices 16 could include a touch screen that enables the user to play digital versatile disks (DVDs) and/or enter destination information, respectively. The peripheral devices 16 could also include a monitor/liquid crystal display (LCD) of a laptop or an ATM. The illustrated integrated computer 14 includes one or more boot components 18 such as a processor, chipset, basic input/output system (BIOS), operating system (OS), drivers, etc., that the integrated computer 14 may use to perform user-related functions. For example, the boot components 18 could include a processor and a BIOS routine that loads one or more drivers from memory in order to facilitate communication between the processor and a particular peripheral device 16.

The illustrated peripheral devices 16 are communicatively coupled to the boot components 18, but are not required by the boot components 18 to perform their normal boot up processes. The communication link between the peripheral devices 16 and the boot components 18 may include, but is not limited to, a PCI (Peripheral Components Interconnect) Express (e.g., PCI Express x16 Graphics 150W-ATX Specification 1.0, PCI Special Interest Group) bus; a USB (e.g., Universal Serial Bus 2.0 Specification) bus, SPI (Serial Peripheral Interconnect) bus, an I²C (e.g., Inter-IC Specification UM10204, Rev. 03, Jun. 19, 2007, NXP Semiconductors) bus, MIPI (Mobile Industry Processor Interface) interface, display interface, camera interface, control interface, input/output (IO) interface, storage interface, network interface, wireless communication interface, legacy interface or any other bus or interconnect interface that enables the peripheral devices 16 to communicate with the boot components 18. Moreover, the peripheral devices 16 may include devices and components of a processor's platform, motherboard or system chassis. Example peripheral devices 16 may include a USB camera, a SATA (e.g., Serial ATA Rev. 3.0 Specification, May 27, 2009, SATA International Organization/SATA-IO) storage drive, an LVDS (Low Voltage Differential Signaling) display panel, a PCI Express graphics card, etc.

As will be discussed in greater detail, the user-based system 10 may also include a proximity sensor 20 such as a radio frequency identifier (RFID) reader/tag, infrared (IR) motion sensor, mechanical switch, Bluetooth (e.g., Institute of Electrical and Electronics Engineers/IEEE 802.15.1-2005, Wireless Personal Area Networks) radio, Wi-Fi IEEE 802.11-2007, Wireless Local Area Network/LAN Medium Access Control (MAC) and Physical Layer (PHY) Specifications) radio, etc., wherein logic 22 may be used to identify a proximity condition between the system 10 and the potential user 12. The proximity condition could specify a certain minimum distance between the system 10 and the potential user 12, as well as one or more authentication parameters. For example, if the system 10 is a vehicle, the proximity sensor 20 could include an RFID reader that interrogates a key transmitter (not shown) carried by the potential user 12 once the potential user 12 is within the read range of the RFID reader in order to determine whether to provide access to the vehicle. The interrogation may be initiated automatically by the logic 22 or manually by the potential user 12 (e.g., upon pressing a button on the key transmitter or the external door handle). The automatic interrogation could be in accordance with a polling mode in which the proximity sensor 20 periodically wakes and checks for potential users. The conduct leading to the detection of the proximity condition is shown generally by arrow 24.

If the proximity condition is detected, the illustrated logic 22 activates one or more of the boot components 18, while maintaining one or more of the peripheral devices 16 in an inactive state. Activating the boot components 18 could involve, for example, initiating a BIOS of the integrated computer 14, booting an OS of the integrated computer 14, loading one or more drivers, etc. Such an approach might be considered a “pre-booting” process that enables certain background components to prepare for anticipated use. Because the illustrated peripheral devices 16 are maintained in an inactive state, however, the pre-booting process is effectively hidden from the potential user 12. For example, in the case of an IVI device, the associated display, touch screen and sound system would remain off so that the occupant is unaware that the pre-booting process is ongoing.

If an activation condition is subsequently detected with respect to the system 10, the logic 22 may then place the peripheral devices 16 in an active state. Arrow 26 generally shows the conduct leading to the detection of the activation condition, which could correspond to a vehicle ignition event (e.g., start up of vehicle), a computing system power button event (e.g., start up of computing system), a keypad event (e.g., start up of ATM), and so forth. The combination of activating the hoot components 18 in response to the proximity condition while maintaining the peripheral devices 16 in an inactive state can cause the latency associated with the boot components 18 to appear to be negligible from the perspective of the potential user 12. Simply put, by the time the peripheral devices 16 are activated, the boot components 18 may have the opportunity to complete the majority, of not all, of their latency related activities.

Thus, in the scenario of a laptop, a potential user might be detected by a proximity sensor associated with the laptop, wherein the detection can initiate a process that either powers on the laptop or brings the laptop out of a sleep state. During this pre-boot process, however, the laptop may appear to be off due to the LCD, keypads and sound system of the laptop being held in an inactive state. When the potential user presses the power button on the keyboard of the laptop, the LCD, keypads and sound system can be switched on, wherein the first thing displayed on the LCD is a login or welcome screen rather than the boot status content that may be scrolled across the display in conventional approaches. Accordingly, the laptop appears to have “instant-on” functionality. Moreover, the laptop may be able to achieve greater power conservation and longer battery life due to the ability to enter sleep and/or inactive states more often.

Similarly, in the scenario of an ATM, a potential user might be detected by a proximity sensor associated with the ATM, wherein the detection can initiate a process that either powers on the ATM or brings the ATM out of a sleep state, and during the pre-boot process the ATM appears to be off When the potential user presses a button on the keypad of the ATM, the LCD of the ATM can be switched on, wherein the first thing displayed to the user is a login or welcome screen. Other user-based systems may also be equipped with instant-on functionality in this fashion.

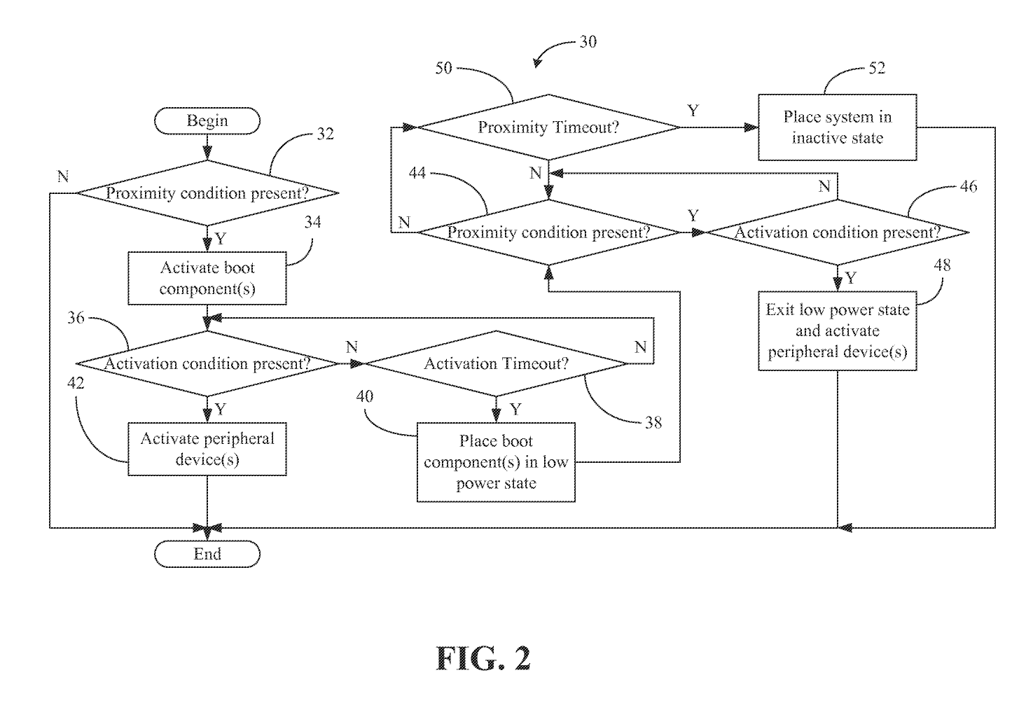

FIG. 2 shows a method 30 of activating a user-based system. The method 30 might be implemented in logic 22 (FIG. 1) of an integrated computer 14 (FIG. 1) as a set of logic instructions stored in a machine- or computer-readable storage medium such as random access memory (RAM), read only memory (ROM), programmable ROM (PROM), firmware, flash memory, etc., in configurable logic such as programmable logic arrays (PLAs), field programmable gate arrays (FPGAs), complex programmable logic devices (CPLDs), in fixed-functionality logic hardware using circuit technology such as application specific integrated circuit (ASIC), complementary metal oxide semiconductor (CMOS) or transistor-transistor logic (TTL) technology, or any combination thereof For example, computer program code to carry out operations shown in method 30 may be written in any combination of one or more programming languages, including an object oriented programming language such as Java, Smalltalk, C++ or the like and conventional procedural programming languages, such as the “C” programming language or similar programming languages.

Processing block 32 provides for determining whether a proximity condition is present with respect to the user-based system and a potential user, which may optionally involve an authentication process such as reading and verifying the potential user's RFID. If the proximity condition is present, one or more boot components may be activated at block 34 in response to the proximity condition. As already noted, various peripheral devices associated with the system can be maintained in an inactive (e.g., low power, power off, etc.) state while the boot components are starting up. Illustrated block 36 may provide for determining whether an activation condition is present. The activation condition may correspond to, for example, an ignition event, an “ON” button event, an activation signaling event (e.g., user pressing a remote control button), a keypad event, and so forth. If so, illustrated block 42 provides for placing the boot components in an active state in response to the activation condition, as already discussed. Otherwise, a determination may be made at block 38 as to whether an activation timeout condition is satisfied. In this regard, the potential user can be given a certain amount of time to activate the system after coming within a certain distance of the system. So long as the prescribed amount of time has not expired, the activation condition evaluation at block 36 may be conducted on an iterative/repetitive basis.

If a timeout is detected at block 38, illustrated block 40 places at least one of the one or more boot components in a low power state. For example, in the case of a processor, the timeout condition could trigger an Advanced Configuration and Power Interface Specification (e.g., ACPI Specification, Ref. 4.0a, Apr. 5, 2010) low power state that significantly reduces the operating voltage of the processor in order to conserve power. Other power reduction techniques may also be used depending upon the circumstances. Once the boot components are placed in the low power state, illustrated block 44 determines whether the proximity condition is still present. If so, a determination may be made at block 46 as to whether the activation condition is present, wherein illustrated block 48 activates the boot components (e.g., exits the low power state) and activates the peripheral devices in response to the activation condition.

If it is determined, however, at block 44 that the proximity condition is no longer present, block 50 may determine whether a proximity timeout condition is satisfied. The proximity timeout condition may afford the user the ability to enter and exit out of the vicinity of the system (e.g., transferring items between a vehicle and a house) so long as prescribed amount of time has not expired. The time period for the proximity timeout condition and the activation timeout condition may be the same or different, depending upon the circumstances. If the proximity timeout condition has been satisfied, illustrated block 52 places the system itself in an inactive state (e.g., completely powers off the system).

Embodiments may therefore include a non-transitory computer readable storage medium including a set of instructions which, if executed by a processor, cause a system to identify a proximity condition between the system and a potential user of the system, and activate one or more boot components of the system in response to the proximity condition. The instructions may also cause the system to maintain one or more peripheral devices associated with the system in an inactive state, wherein the inactive state is to include at least one of a low power state and a power off state.

Embodiments may also include a system having one or more peripheral devices, one or more boot components, a proximity sensor and logic to identify a proximity condition between the system and a potential user of the system based on data from the proximity sensor. The logic can also activate at least one of the one or more hoot components in response to the proximity condition, and maintain the peripheral device in an inactive state. The inactive state may include at least one of a low power state and a power off state.

Other embodiments may include a computer implemented method in which a proximity condition is identified between a system and a potential user of the system. The method can also involve activating one or more boot components of the system in response to the proximity condition and maintaining one or more peripheral devices associated with the system in an inactive state. The inactive state may include at least one of a low power state and a power off state.

Thus, techniques described herein enable perceived boot latency to be significantly reduced without the need for specialized or dedicated boot loaders or operating systems. Leveraging proximity-based detection in the context of boot time reduction can lead to improved user experience in a wide variety of settings including, but not limited to, context aware computing systems, industrial control systems, embedded systems, Web TVs, set-top boxes, ATMs, IVI systems and navigation systems. In addition, techniques described herein may enable systems to reduce overall power consumption by enabling some intelligence to activate system components when a potential user is nearby, and to deactivate system components when there are no potential users nearby.

Embodiments described herein are applicable for use with all types of semiconductor integrated circuit (“IC”) chips. Examples of these IC chips include but are not limited to processors, controllers, chipset components, programmable logic arrays (PLAs), memory chips, network chips, digital signal processing (DSP) chips and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more wired or wireless signals that may travel in multiple directions and may be implemented with any suitable type of signal scheme, e.g.,. digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A system comprising:
one or more peripheral devices;
one or more boot components;
a proximity sensor; and
logic to,
identify a proximity condition between the system and a potential user of the system based on a signal from the proximity sensor,
activate at least one of the one or more boot components of the system in response to the proximity condition, and
maintain at least one of the one or more peripheral devices in an inactive state, wherein the inactive state is to include at least one of a low power state and a power off state.

2. The system of claim 1, wherein the logic is to,
detect an activation condition of the system, wherein the activation condition is to correspond to at least one of an ignition event, an ON button event, an activation signaling event and a keypad event, and
activate at least one of the one or more peripheral devices in response to the activation condition.

3. The system of claim 1, wherein the logic is to,
detect an activation timeout condition, and
place at least one of the one or more boot components in a low power state in response to the activation timeout condition.

4. The system of claim 3, wherein the logic is to,
detect an activation condition, wherein the activation condition is to correspond to at least one of an ignition event, an ON button event, an activation signaling event and a keypad event, and
activate at least one of the one or more boot components and at least one of the one or more peripheral devices in response to the activation condition.

5. The system of claim 3, wherein the logic is to,
detect an end of the proximity condition,
detect a proximity timeout condition, and
place the system in an inactive state in response to the end of the proximity condition and the proximity timeout condition.

6. The system of claim 1, wherein at least one of the one or more boot components includes at least one of a basic input/output system (BIOS), a boot loader, an operating system (OS) and a driver, and wherein the logic is to at least one of:
initiate the BIOS,
initiate the boot loader,
boot the OS, and
load the driver.

7. A computer implemented method comprising:
identifying a proximity condition between a system and a potential user of the system;
activating one or more boot components of the system in response to the proximity condition; and
maintaining one or more peripheral devices associated with the system in an inactive state, wherein the inactive state includes at least one of a low power state and a power off state.

8. The method of claim 7, further including:
detecting an activation condition of the system, wherein the activation condition corresponds to at least one of an ignition event, an ON button event, an activation signaling event and a keypad event; and
activating at least one of the one or more peripheral devices in response to the activation condition.

9. The method of claim 7, further including:
detecting an activation timeout condition; and
placing at least one of the one or more boot components in a low power state in response to the activation timeout condition.

10. The method of claim 9, further including:
detecting an activation condition, wherein the activation condition corresponds to at least one of an ignition event, an ON button event, an activation signaling event and a keypad event; and
activating at least one of the one or more boot components and at least one of the one or more peripheral devices in response to the activation condition.

11. The method of claim 9, further including:
detecting an end of the proximity condition;
detecting a proximity timeout condition; and
placing the system in an inactive state in response to the end of the proximity condition and the proximity timeout condition.

12. The method of claim 7, wherein activating at least one of the one or more boot components includes:
initiating a basic input/output system (BIOS) of the system;
initiating a boot loader of the system;
booting an operating system (OS) of the system; and
loading one or more drivers.

13. The method of claim 7, wherein the proximity condition is identified between the potential user and at least one of an in-vehicle infotainment (IVI) system, a navigation system, an industrial control system, an embedded system, a computing system and an automated teller machine (ATM).

14. A non-transitory computer readable storage medium comprising a set of instructions which, if executed by a processor, cause a system to:
identify a proximity condition between the system and a potential user of the system;
activate one or more boot components of the system in response to the proximity condition; and
maintain one or more peripheral devices associated with the system in an inactive state, wherein the inactive state is to include at least one of a low power state and a power off state.

15. The medium of claim 14, wherein the instructions, if executed, cause the system to:
detect an activation condition of the system, wherein the activation condition is to correspond to at least one of an ignition event, an ON button event, an activation signaling event and a keypad event; and
activate at least one of the one or more peripheral devices in response to the activation condition.

16. The medium of claim 14, wherein the instructions, if executed, cause the system to:
detect an activation timeout condition; and
place at least one of the one or more boot components in a low power state in response to the activation timeout condition.

17. The medium of claim 16, wherein the instructions, if executed, cause the system to:
detect an activation condition, wherein the activation condition is to correspond to at least one of an ignition event, an ON button event, an activation signaling event and a keypad event; and
activate at least one of the one or more boot components and at least one of the one or more peripheral devices in response to the activation condition.

18. The medium of claim 16, wherein the instructions, if executed, cause the system to:
detect an end of the proximity condition;
detect a proximity timeout condition; and
place the system in an inactive state in response to the end of the proximity condition and the proximity timeout condition.

19. The medium of claim 14, wherein the instructions, if executed, cause the system to at least one of:
initiate a basic input/output system (BIOS) of the system;
initiate a boot loader of the system;
boot an operating system (OS) of the system; and
load one or more drivers.

20. The medium of claim 14, wherein the proximity condition is to be identified between the potential user and at least one of an in-vehicle infotainment (IVI) system, a navigation system, an industrial control system, an embedded system, a computing system and an automated teller machine (ATM).
